(19) United States
(12) Patent Application Publication
(10) Pub. No.: US 2021/0167908 A1
(43) Pub. Date: Jun. 3, 2021

(54) SUPPLEMENTAL NARROWBAND WIRELESS ACCESS CHANNEL

(71) Applicant: Charter Communications Operating, LLC, St. Louis, MO (US)

(72) Inventors: Saran Khalid, Denver, CO (US); Mohammedyusuf M. Shaikh, Denver, CO (US)

(21) Appl. No.: 16/700,133

(22) Filed: Dec. 2, 2019

(51) Int. Cl. H04L 5/00; H04W 16/14; H04L 5/14; H04W 72/04

(52) U.S. Cl. CPC H04L 5/0037; H04W 16/14; H04W 72/0453; H04W 72/042; H04L 5/143

(57) ABSTRACT

A network environment includes a wireless base station, customer premises equipment, and one or more mobile communication devices. Communication management hardware associated with the wireless base station provides different types of wireless connectivity via the wireless base station. For example, the communication management hardware initially receives allocation of a first wireless channel. The communication management hardware uses the first wireless channel to establish wireless connectivity between the wireless base station and the customer premises equipment. Via an established narrowband wireless channel associated with the first wireless channel, the wireless base station supports narrowband wireless communications between the wireless base station and a mobile communication device present in the network environment.

### BACKGROUND

Conventional wireless systems support different types of wireless connectivity. For example, conventional wireless systems support fixed wireless access (FWA) connectivity between a wireless base station and so-called customer premises equipment. The customer premises equipment provides network access to multiple mobile communication devices.

Fixed wireless access is a cost effective option to provide broadband wireless services in rural areas requiring minimal equipment compared to hardwired networks (such as coaxial cable, optical fiber, etc.). In general, customer premises equipment (CPE) processes mobile broadband data and routes the data to the router for customer access through ethernet or WiFi™.

Certain wireless systems implement a so-called guard band between channels. For example, a guard band is an unused part of the radio spectrum between radio channels. The purpose of the guard band is to prevent interference. For example, a conventional guard band is typically a narrow frequency range used to separate two wider frequency ranges to ensure that both can transmit simultaneously without interfering with each other.

### BRIEF DESCRIPTION OF EMBODIMENTS

In contrast to conventional systems, embodiments herein provide novel use of wireless bandwidth to provide different types of communications in a wireless network environment.

More specifically, according to one embodiment, a wireless network environment includes a wireless base station, customer premises equipment, and one or more mobile communication devices. A communication management resource associated with the wireless base station provides different types of wireless connectivity via the wireless base station. For example, the communication management hardware initially receives allocation of a first wireless channel. Via the first wireless channel, the communication management hardware establishes wireless connectivity between the wireless base station and the customer premises equipment. Via a narrowband wireless channel associated with the first wireless channel, the wireless base station supports narrowband wireless communications between the wireless base station and one or more mobile communication devices present in the network environment.

In accordance with further embodiments, the first wireless channel supports time-division duplex wireless communications; the narrowband wireless channel supports frequency-division duplex wireless communications.

In accordance with still further embodiments, the communication management resource as described herein establishes the narrowband wireless channel in a guard band associated with the first wireless channel. In one embodiment, the guard band is disposed between the first wireless channel and a second wireless channel of a communication system.

In yet further embodiments, the narrowband wireless channel is a first narrowband wireless channel associated with the first wireless channel. In one non-limiting example embodiment, the communication management resource is further operative to: i) establish the first narrowband wireless channel in a first guard band associated with the first wireless channel; and ii) establish a second narrowband wireless channel in a second guard band associated with the first wireless channel, a combination of the first narrowband wireless channel (such as for downlink messages) and the second narrowband wireless channel (such as for uplink messages) supporting full duplex communications.

Yet further embodiments herein include, via the communication management resource, communicating a message over the narrowband wireless channel to the mobile communication device. The messages can include any suitable information. In such an instance, the message indicates availability of services associated with the wireless connectivity and narrowband capability.

Still further embodiments herein include, via the communication management resource, communicating a message over the narrowband wireless channel to the mobile communication device. In one embodiment, the narrowband message indicates availability of content retrievable over the wireless connectivity for playback by the mobile communication device.

In accordance with yet further example embodiments, the wireless base station operates in the CBRS (Citizen Band Radio System) band between 3.550 and 3.7 GigaHertz (GHz). In one embodiment, the communication management resource receives allocation of the first wireless channel from a spectrum access system or other suitable entity. The spectrum access system assigns use of different wireless channels to multiple base stations in the network environment. Thus, in one embodiment, the first wireless channel is allocated from a CBRS (Citizen Band Radio System) wireless spectrum including multiple wireless channels.

As previously discussed, the first wireless channel can be allocated for use as a time-division duplex wireless channel. In one embodiment, the communication management resource associated with the wireless base station allocates a portion of bandwidth associated with the first wireless channel to implement the narrowband wireless channel or multiple narrow band wireless channels.

Further embodiments herein include, via the communication management resource, adjusting a magnitude of a carrier frequency and/or wireless band occupied by the narrowband wireless channel. For example, the narrowband wireless channel can be adjusted to be within or outside a guard band associated with the first wireless channel.

In yet further example embodiments, the communication management resource can be configured to switchover from using the first wireless channel to using a second wireless channel. For example, in response to receiving input indicating that the first wireless channel is no longer available for use, the communication management resource terminates the wireless connectivity between the wireless base station and the customer premises equipment. In response to receiving assignment of a second wireless channel to be used in lieu of the first wireless channel, the communication management resource re-establishes the wireless connectivity between the wireless base station and the customer premises equipment. Additionally, the communication management resource re-establishes one or more narrowband wireless channels between the wireless base station and the mobile communication device via bandwidth associated with the second wireless channel. The re-established one or more narrowband wireless channels support respective narrowband wireless communications between the wireless base station and the mobile communication devices.

In still further example embodiments, the communication management resource establishes the narrowband wireless channel in a guard band associated with the first wireless channel prior to assignment of a second wireless channel to the wireless base station. In one embodiment, if the second wireless channel is no longer available, the communication management resource establishes the narrowband wireless channel in a guard band associated with the second wireless channel (instead of the first wireless channel) subsequent to assignment of the second wireless channel to the wireless base station.

Embodiments herein are useful over conventional techniques. For example, embodiments herein provide more efficient use of wireless bandwidth to support different types of wireless connectivity in a network environment.

Note that any of the resources as discussed herein can include one or more communication management resources, computerized devices, mobile communication devices, sensors, servers, base stations, wireless communication equipment, communication management systems, controllers, workstations, user equipment, handheld or laptop computers, or the like to carry out and/or support any or all of the method operations disclosed herein. In other words, one or more computerized devices or processors can be programmed and/or configured to operate as explained herein to carry out the different embodiments as described herein.

Yet other embodiments herein include software programs to perform the steps and operations summarized above and disclosed in detail below. One such embodiment comprises a computer program product including a non-transitory computer-readable storage medium (i.e., any computer readable hardware storage medium) on which software instructions are encoded for subsequent execution. The instructions, when executed in a computerized device (hardware) having a processor, program and/or cause the processor (hardware) to perform the operations disclosed herein. Such arrangements are typically provided as software, code, instructions, and/or other data (e.g., data structures) arranged or encoded on a non-transitory computer readable storage medium such as an optical medium (e.g., CD-ROM), floppy disk, hard disk, memory stick, memory device, etc., or other medium such as firmware in one or more ROM, RAM, PROM, etc., or as an Application Specific Integrated Circuit (ASIC), etc. The software or firmware or other such configurations can be installed onto a computerized device to cause the computerized device to perform the techniques explained herein.

Accordingly, embodiments herein are directed to a method, system, computer program product, etc., that supports operations as discussed herein.

One embodiment includes computer readable storage hardware, computer readable storage medium and/or system having instructions stored thereon. The instructions, when executed by the computer processor hardware, cause the computer processor hardware (such as one or more co-located or disparately processor devices or hardware) to: receive allocation of a first wireless channel; via the first wireless channel, establish wireless connectivity between a wireless base station and first customer premises equipment in a network environment; and via a narrowband wireless channel associated with the first wireless channel, support narrowband wireless communications between the wireless base station and a mobile communication device present in the network environment.

The ordering of the steps above has been added for clarity sake. Note that any of the processing steps as discussed herein can be performed in any suitable order.

Other embodiments of the present disclosure include software programs and/or respective hardware to perform any of the method embodiment steps and operations summarized above and disclosed in detail below.

It is to be understood that the system, method, apparatus, instructions on computer readable storage media, etc., as discussed herein also can be embodied strictly as a software program, firmware, as a hybrid of software, hardware and/or firmware, or as hardware alone such as within a processor (hardware or software), or within an operating system or a within a software application.

As discussed herein, techniques herein are well suited for use in the field of wireless communications. However, it should be noted that embodiments herein are not limited to use in such applications and that the techniques discussed herein are well suited for other applications as well.

Additionally, note that although each of the different features, techniques, configurations, etc., herein may be discussed in different places of this disclosure, it is intended, where suitable, that each of the concepts can optionally be executed independently of each other or in combination with each other. Accordingly, the one or more present inventions as described herein can be embodied and viewed in many different ways.

Also, note that this preliminary discussion of embodiments herein (BRIEF DESCRIPTION OF EMBODIMENTS) purposefully does not specify every embodiment and/or incrementally novel aspect of the present disclosure or claimed invention(s). Instead, this brief description only presents general embodiments and corresponding points of novelty over conventional techniques. For additional details and/or possible perspectives (permutations) of the invention(s), the reader is directed to the Detailed Description section (which is a summary of embodiments) and corresponding figures of the present disclosure as further discussed below.

### BRIEF DESCRIPTION OF THE DRAWINGS

FIG. 1 is an example diagram illustrating a wireless base station supporting multiple types of wireless communication protocols and corresponding wireless communications including supplemental narrowband wireless connectivity according to embodiments herein.

FIG. 2 is an example diagram illustrating an example bandwidth spectrum for implementing standard wireless access and supplemental narrowband wireless access according to embodiments herein.

FIG. 3 is an example diagram illustrating use of one or more guard-bands supporting narrowband communications according to embodiments herein.

FIG. 4 is an example diagram illustrating use of one or more guard-bands supporting narrowband communications according to embodiments herein.

FIG. 5 is an example diagram illustrating use of one or more guard-bands supporting narrowband communications according to embodiments herein.

FIG. 6 is an example diagram illustrating use of a portion of an allocated channel (bandwidth) to provide narrowband wireless connectivity according to embodiments herein.

FIG. 7 is an example diagram illustrating use of a different portions of multiple allocated channels (bandwidth) to provide narrowband wireless connectivity according to embodiments herein.

FIG. 8 is an example diagram illustrating a network environment implementing communication management and one or more wireless base stations implementing different types of wireless communication links according to embodiments herein.

FIG. 9 is an example diagram illustrating a wireless communication system supporting multiple types of wireless connectivity according to embodiments herein.

FIG. 10 is an example diagram illustrating example computer hardware and software that execute operations according to embodiments herein.

FIG. 11 is an example diagram illustrating a method according to embodiments herein.

The foregoing and other objects, features, and advantages of the invention will be apparent from the following more particular description of preferred embodiments herein, as illustrated in the accompanying drawings in which like reference characters refer to the same parts throughout the different views. The drawings are not necessarily to scale, with emphasis instead being placed upon illustrating the embodiments, principles, concepts, etc.

### DESCRIPTION OF EMBODIMENTS

According to one embodiment, a network environment includes a wireless base station, customer premises equipment, and one or more mobile communication devices. A communication management resource associated with the wireless base station implements different types of wireless connectivity via the wireless base station. For example, in one embodiment, the communication management resource initially receives allocation of a first wireless channel for standard wireless communications. Using the allocated first wireless channel, the communication management resource establishes first wireless connectivity between the wireless base station and the customer premises equipment. Via a supplemental narrowband wireless channel associated with the first wireless channel, the wireless base station supports narrowband wireless communications between the wireless base station and one or more mobile communication devices present in the network environment. Thus, a wireless base station supports multiple types of connectivity.

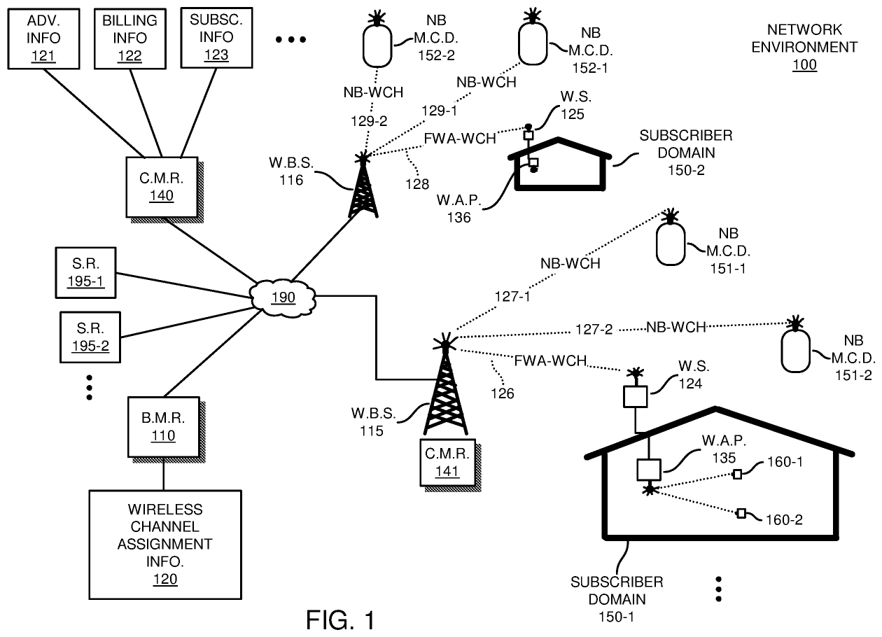

Now, with reference to the drawings, FIG. 1 is an example diagram illustrating a network environment including a communication management resource and one or more wireless stations implementing different types of wireless communication links according to embodiments herein.

As shown, wireless network environment 100 includes communication management resource 140, network 190, server resource 195-1, server resource 195-2, wireless base stations 115, 116, etc., bandwidth management resource 110, wireless station 124 (such as customer premises equipment), wireless access point 135, wireless station 125 (such as customer premises equipment), wireless access point 136, narrowband mobile communication devices 151, 152, etc. Wireless access point 135 provides wireless connectivity to the mobile communication devices 160-1, 160-2, etc., in subscriber domain 150-1.

Note that each of the processing entities in network environment 100 can be implemented via hardware, software, or a combination of hardware/software. For example, communication management resource 140 can be implemented as communication management hardware, communication management software, or a combination of both; communication management resource 141 can be implemented as communication management hardware, communication management software, or a combination of both; bandwidth management resource 110 can be implemented as bandwidth management hardware, bandwidth management software, or a combination of both; narrowband device 151 can be implemented as narrowband device hardware, narrowband device software, or a combination of both; wireless station 115 can be implemented as wireless station hardware, wireless station software, or a combination of both; and so on.

In general, each of the one or more the wireless base stations 115, 116, etc., supports multiple different types of wireless communication links in network environment 100.

For example, in one embodiment, wireless base station 115 supports wireless communications over wireless communication link 126 (wireless connectivity) as well as wireless communication links 127-1 and 127-2.

Wireless communication link 127 supports wireless communications (such as wideband communications) between the wireless base station 115 and the wireless station 124 (such as customer premises equipment) in accordance with a first wireless communication protocol such as LTE. Wireless base station 115 and corresponding communication management resource 141 can be configured to support wideband connectivity with any number of wireless stations (such as different customer premises equipment disposed in different subscriber domains).

Wireless communication link 127-1 supports wireless communications (such as a first narrowband communications) between the wireless base station 115 and the narrowband device 151-1.

Wireless communication link 127-2 supports wireless communications (such as a second narrowband communications) between the wireless base station 115 and the narrowband device 151-2.

In one embodiment, assume that the wireless base station 115 initially receives allocation of a first wireless channel. Via the first wireless channel (such as a fixed wireless access channel FWA-WCH or other suitable wireless channel), the communication management resource 141 of wireless base station 115 establishes wireless connectivity 126 between the wireless base station 115 and the wireless station 124.

As further discussed herein, the communication management resource 141 associated with wireless base station 115 derives one or more supplemental narrowband wireless channels (namely, NB-WCH) based on the assigned first wireless channel (WCH #1). Via a narrowband wireless channel (NB-WCH) associated with the first wireless channel (WCH #1), the wireless base station 115 supports narrowband wireless communications between the wireless base station 115 and narrowband-enabled mobile communication devices 151-1, 151-2, etc., (such as NB-IoT enabled devices) present in the network environment 100.

In a similar manner, the communication management resource associated with wireless base station 116 derives one or more supplemental narrowband wireless channels (namely, NB-WCH) based on a respective assigned second wireless channel (WCH #2). Via a narrowband wireless channel (NB-WCH) associated with the second wireless channel (WCH #2), the wireless base station 116 supports narrowband wireless communications via wireless connectivity 129 (such as wireless links 129-1 and 129-2) between the wireless base station 116 and narrowband-enabled mobile communication devices 152-1, 152-2, etc., (such as NB-IoT enabled devices) present in the network environment 100.

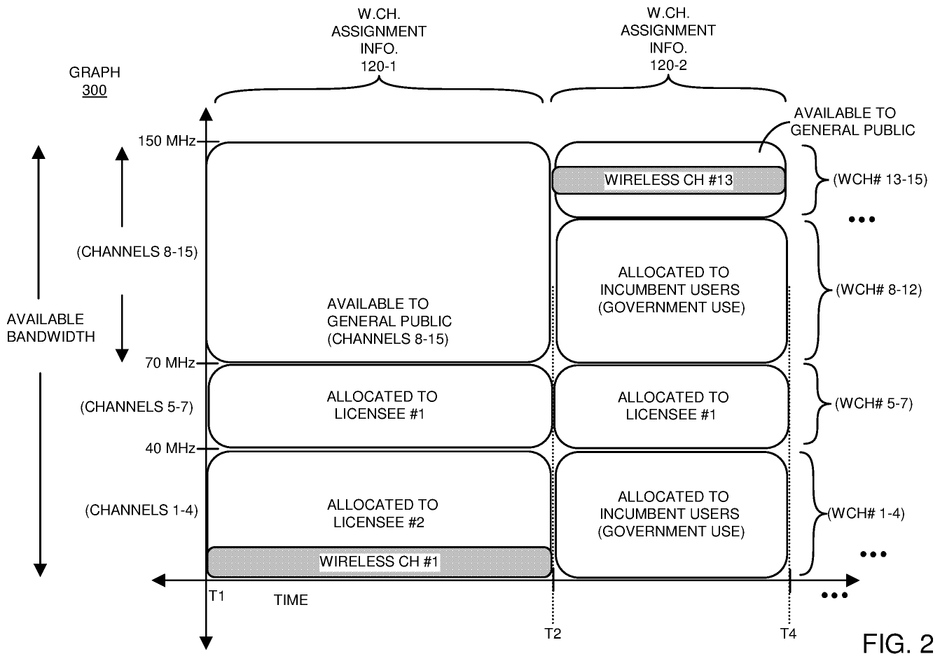

FIG. 2 is an example diagram illustrating channel usage at different times according to embodiments herein.

In one embodiment, the bandwidth management resource 110 (such as a spectrum access system or other suitable allocation resource) allocates one or more wireless channels associated with a CBRS wireless band (other suitable band) to the wireless base stations in network environment 100.

In this example embodiment, the available bandwidth includes multiple wireless channels including wireless channels 1-15. In one embodiment, the wireless channels 1-7 are PAL wireless channels. The wireless channels 8-15 are GAA channels.

Between time T1 and time T2, as indicated by the wireless channel assignment information 120-1, the bandwidth management resource 110 allocates wireless channel #1 to the wireless base station 115.

At any time, allocation of wireless channels can change. For example, at time T2, assume that an incumbent user (such as the government) acquires use of wireless channels 1-4. In such an instance, the wireless channels 1-4 are no longer available. Assume in this example embodiment that the bandwidth management resource allocates wireless channel #13 to the wireless base station 115 for use between time T2 and T4 in response to detecting government use of wireless channels 1-4.

In accordance with another example embodiment, note that the bandwidth management resource 110 can be configured to allocate a different wireless channel such as wireless channel #3 to the user in response to a condition in which the wireless channel #1 is allocated for use by another entity.

Accordingly, in one embodiment, the bandwidth management resource 110 can be configured to allocate more desirable PAL (Priority Access License) or licensed wireless channels to higher tiered entities. In one embodiment, the government has highest priority use, priority access license users having a next highest priority use, and the general public has a last priority of use. The use of wireless channels varies on an as-needed basis.

Several embodiments as discussed below illustrate reassignment of different wireless channels over time and use of such wireless channels to establish multiple different types of wireless connectivity (such as narrowband connectivity via wireless communication links 127 and broadband connectivity via wireless communication link 126).

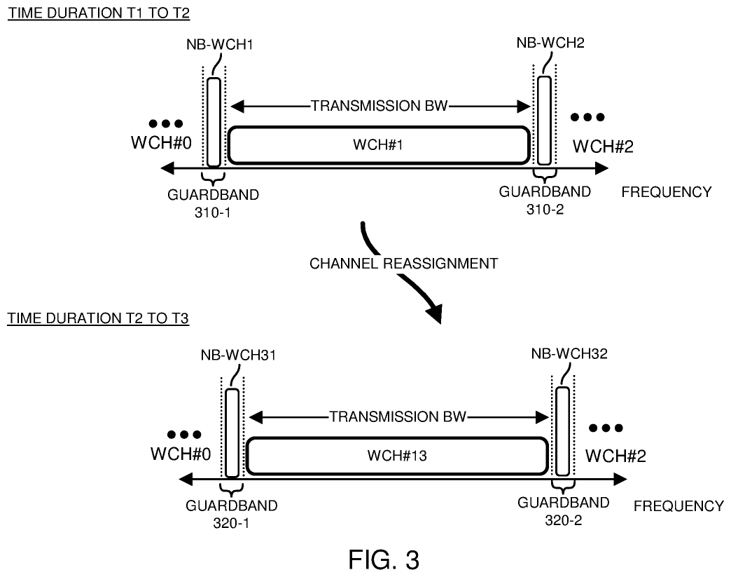

FIG. 3 is an example diagram illustrating use of one or more guard-bands supporting narrowband communications according to embodiments herein.

As shown in this example embodiment, assume that the wireless station 124 (such as customer premises equipment) receives allocation of a first wireless channel such as channel #1 (WCH #1) for use between time T1 and time T2. As previously discussed, the wireless channel #1 can be allocated by the bandwidth management resource 110 or other suitable entity.

Via the wireless channel #1, the combination of wireless base station 115 and wireless station 124 establish wireless access connectivity 126 between the wireless base station 115 and the wireless station 124.

In addition to establishing wireless connectivity 126, in one embodiment, the wireless base station 115 identifies guard bands adjacent to the assigned wireless channel WCH #1 such as between wireless channel WCH #1 and each of the wireless channels WCH #0 (to the left) and WCH #2 (to the right). In this example embodiment, the wireless base station 115 identifies guard band 310-1 and 310-2 as being available and adjacent to assigned wireless channel WCH #1.

In such an instance, the wireless base station 115 (and corresponding communication management resource 141) establishes narrowband wireless channel connectivity 127-1, 127-2, etc., in one or more of guard bands 310-1, 310-2, etc., associated with wireless channel WCH #1. Between time T1 and T2, the wireless base station 115 supports narrowband wireless communications with each of the mobile communication devices 151-1, 151-2, etc., via the narrowband wireless channels NB-WCH1 and NB-WCH2 (such as implemented in one or more of guard bands 310-1, 310-2, etc.) associated with the first wireless channel WCH #1.

Thus, in accordance with embodiments, the communication management resource 141 and wireless base station 115 as described herein establish the narrowband wireless channel connectivity 127 in one or more guard bands 310-1 and/or 310-2 associated with the first wireless channel (WCH #1).

In accordance with further embodiments, the first wireless channel WCH #1 and corresponding wireless connectivity 126 (such as a FWA-WCH) can be configured to support time-division duplex wireless communications; the narrowband wireless channels NB-WCH (NB-WCH1 and NB-WCH2) in one or more of guard bands 310-1 and 310-2 support frequency-division duplex wireless communications.

More specifically, the communication management resource 141 and corresponding wireless base station 115: i) establishes a first narrowband wireless NB-WCH1 in a first guard band 310-1 associated with the first wireless channel WCH #1, and ii) establishes a second narrowband wireless channel NB-WCH2 in a second guard band 310-2 associated with the first wireless channel WCH #1.

In one embodiment, a combination of the first narrowband wireless channel NB-WCH1 (such as for uplink communication) and the second narrowband wireless channel NB-WCH2 (such as for downlink communications) support full duplex communications.

For example, the first narrow band wireless channel NB-WCH #1 can be configured to support communications from the wireless base station 115 to the mobile communication devices 151; the second narrow band wireless channel NB-WCH #2 can be configured to support communications from the mobile communication devices 151 to the wireless base station 115.

As previously discussed, and as further discussed herein, the narrow band wireless channels in respective guard bands 310-1 and 310-2 can be configured to support different types of messages or include different information such as advertisement information 121, billing information 122, subscriber information 123, etc., as previously discussed.

In one embodiment, the wireless base station 115 narrow band messages communicated from the wireless base station 115 indicates availability of services associated with the wireless connectivity 126 (supporting substantially higher bandwidth communications). By way of non-limiting example embodiment, the communications over wireless connectivity 126 and corresponding wireless channel WCH #1 can be configured to support more than 10 times more bandwidth than bandwidth associated with the guard bands 310 and corresponding narrow band channels NB-WCH1 and NB-WCH2.

As a further example of using the narrow band wireless channels, embodiments herein can include, via the communication management resource 141, communicating a message over the narrowband wireless channel NB-WCH1 and wireless connectivity 127-1 to the mobile communication device 151-1. In such an instance, assume that the communicated narrowband message indicates availability of content retrievable over the wireless connectivity 126 for playback by the mobile communication device 151-1. The mobile communication device 151-1 displays a respective message on a display screen of the mobile communication device 151-1 indicating the availability of content in response to receiving the narrow band message.

In response to receiving the displayed notification, assume that the user of the mobile communication device 151-1 selects an option to view the content (such as video content). Because the wireless connectivity 127-1 does not support high bandwidth communications such as the retrieval of the video content, the mobile communication device 151-1 establishes an additional wireless communication link with the wireless base station 115 using the wireless channel #1 and wireless connectivity 126.

Via the additional wireless communication link via wireless connectivity 126 (such as based on wireless channel WCH #1 or another assigned wireless channel) between the wireless base station 115 and the mobile communication device 151-1, the mobile communication device 151-1 communicates with the wireless base station 115 to retrieve the video content. Thus, the wireless connectivity 127 can be used to provide notice of available content while the alternative wireless channel WCH #1 is used to retrieve the high bandwidth content.

As further shown in FIG. 3, in yet further example embodiments, the communication management resource can be configured to switchover from using the first wireless channel to using a second wireless channel in response to receiving a reassignment notice from the bandwidth management resource 110.

For example, assume that the wireless channel WCH #1 is no longer available for use at or around time T2. In such an instance, the bandwidth management resource 110 or other suitable entity notifies the wireless base station 115 that the wireless channel WCH #1 and corresponding use by the wireless base station 115 has been terminated. The bandwidth management resource 110 also notifies the wireless base station 115 that wireless channel WCH #13 is newly allocated for its use.

In response to receiving input (such as a communication from the bandwidth management resource 110) indicating that the first wireless channel WCH #1 is no longer available or assigned for use, the communication management resource 140 terminates the wireless connectivity 126 and 127 between the wireless base station 115 and the wireless station 124 (such as customer premises equipment). In response to receiving assignment of a second wireless channel (such as WCH #13) to be used in lieu of the first wireless channel WCH #1, the communication management resource 141 identifies new guard bands 320-1 and 320-2 associated with the WCH #13 and then re-establishes the wireless connectivity 126 (such as via wireless channel WCH #13) and 127 (such as via NB-WCH31 and NB-WCH32) between the wireless base station 115 and the wireless station 124 (customer premises equipment).

Additionally, as shown in FIG. 3, between time T2 and time T3, the communication management resource 141 re-establishes one or more narrowband wireless channels between the wireless base station 115 and one or more mobile communication devices via bandwidth associated with the second wireless channel (WCH #13). Via wireless connectivity 127, the one or more re-established narrowband wireless channels (such as narrow band wireless channels NB-WCH31 in guard band 320-1 and NB-WCH32 in guard band 320-2) support respective narrowband wireless communications between the wireless base station 115 and the mobile communication devices 151.

Thus, in this example embodiment, assignment of a new wireless channel to the wireless station 115 prompts a change in carrier frequencies and corresponding wireless channels and bandwidth used to convey data over the different types of wireless connectivity.

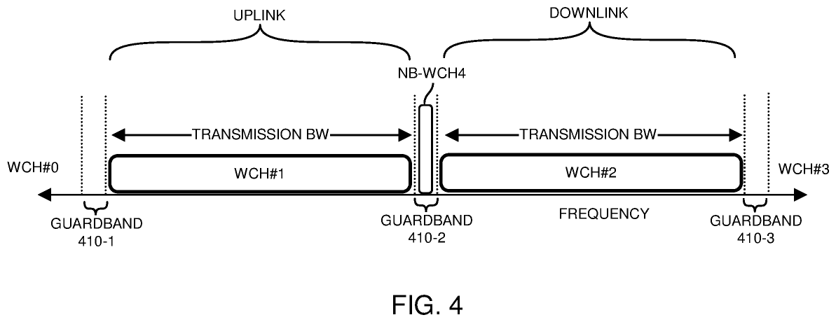

FIG. 4 is an example diagram illustrating use of one or more guard-bands supporting narrowband communications according to embodiments herein.

In this example embodiment, assume that the bandwidth management resource 110 allocates use of multiple wireless channels WCH #1 and WCH #2 to the wireless base station 115 to support respective wireless connectivity 126 and wireless connectivity 127.

In such an instance, the communication management resource 141 identifies guard band 410-1 as being available between the multiple assigned wireless channels WCH #1 and WCH #2.

In one embodiment, the wireless base station 115 is limited to selecting and using guard bands available between two adjacent assigned wireless channels (such as wireless channels WCH #1 and WCH #2 in this case).

In response to detecting availability of guard band 410-2 between adjacent assigned wireless channels WCH #1 and WCH #2, the wireless base station 115 uses the wireless channels WCH #1 and WCH #2 to support communications over wireless connectivity 126 and narrow band wireless channel NB-WCH4 (in identified guard band 410-2) to support communications over wireless connectivity 127-1 and wireless connectivity 127-2.

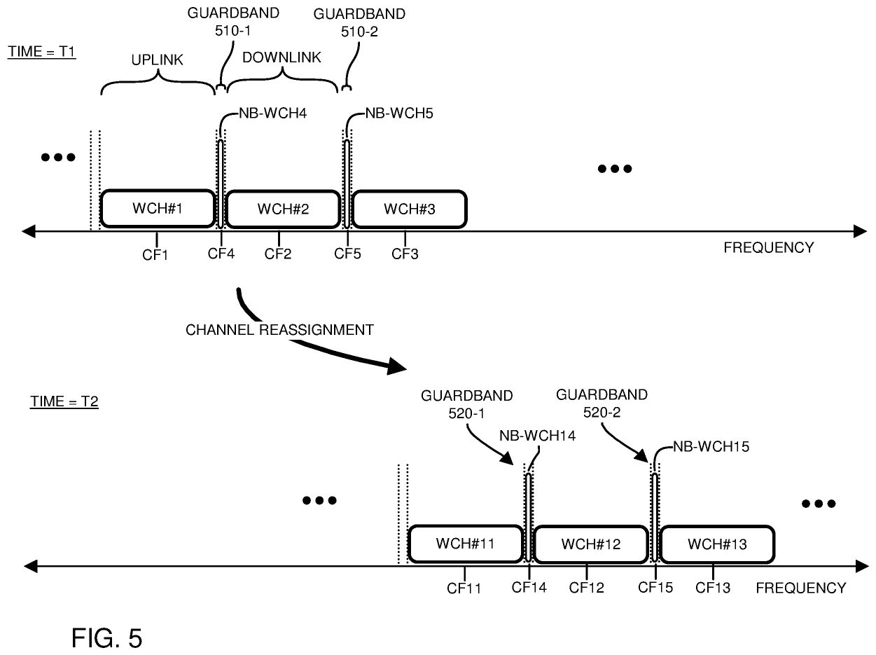

FIG. 5 is an example diagram illustrating use of one or more guard-bands supporting narrowband communications according to embodiments herein.

In this example embodiment, assume that the bandwidth management resource 110 allocates use of multiple wireless channels WCH #1, WCH #2, and WCH #3 to the wireless base station 115 to support wireless connectivity 126 and 127 at or around time T1.

In such an instance, the communication management resource 141 identifies guard band 510-1 as being available between the multiple assigned wireless channels WCH #1 and WCH #2. The communication management resource 141 identifies guard band 510-2 as being available between the multiple assigned wireless channels WCH #2 and WCH #3.

In one embodiment, the wireless base station 115 is limited to selecting and using guard bands available between two adjacent assigned wireless channels (such as guard band 510-1 between wireless channels WCH #1 and WCH #2 and guard band 510-2 between wireless channels WCH #2 and WCH #3 in this case).

In response to detecting availability of guard bands 510-1 and 510-2 between pairs of adjacent assigned wireless channels such as pair WCH #1 and WCH #2 and pair WCH #2 and WCH #3, the wireless base station 115 uses the wireless channels WCH #1, WCH #2, and WCH #3 to support broad band communications via wireless connectivity 126.

The wireless base station 115 uses narrow band wireless channels NB-WCH4 and NB-WCH5 to support narrow band communications over wireless connectivity 127-1, 127-2, etc.

In one embodiment, each of the wireless channels supports a different carrier frequency. For example, WCH #1 has a carrier frequency of CF1 in the center of the respective channel band; WCH #2 has a carrier frequency of CF2 in the center of the respective channel band; WCH #3 has a carrier frequency of CF3 in the center of the respective channel band; NB-WCH4 has a carrier frequency of CF4 in the center of the respective channel band; NB-WCH5 has a carrier frequency of CF5 in the center of the respective channel band; and so on.

Assume further in this example embodiment that the bandwidth management resource 110 detects a condition in which an incumbent user or other entity needs to use wireless channels #1, #2, and #3. Assume that the bandwidth management resource 110 assigns the wireless base station use of alternative wireless channels WCH #11, WCH #12, and WCH #13.

In such an instance, the communication management resource 141 identifies guard band 520-1 as being available between the multiple assigned wireless channels WCH #11 and WCH #12. The communication management resource 141 identifies guard band 520-2 as being available between the multiple assigned wireless channels WCH #12 and WCH #13.

In one embodiment, the wireless base station 115 is limited to selecting and using guard bands available between two adjacent assigned wireless channels (such as guard band 520-1 between wireless channels WCH #11 and WCH #12 and guard band 520-2 between wireless channels WCH #12 and WCH #13 in this case).

In response to detecting availability of guard bands 520-1 and 520-2 between pairs of adjacent assigned wireless channels such as pair WCH #11 and WCH #12 and pair WCH #12 and WCH #13, the wireless base station 115 uses the wireless channels WCH #11, WCH #12, and WCH #13 to support communications over wireless connectivity 126. The wireless base station 115 uses narrow band wireless channels NB-WCH14 in guard band 520-1 and NB-WCH15 in guard band 520-2 to support communications over wireless connectivity 127-1, 127-2, etc.

In one embodiment, each of the wireless channels supports a different carrier frequency. For example, WCH #11 has a carrier frequency of CF11 in the center of the respective channel band; WCH #12 has a carrier frequency of CF12 in the center of the respective channel band; WCH #13 has a carrier frequency of CF13 in the center of the respective channel band; NB-WCH14 has a carrier frequency of CF14 in the center of the respective channel band; NB-WCH15 has a carrier frequency of CF15 in the center of the respective channel band; and so on.

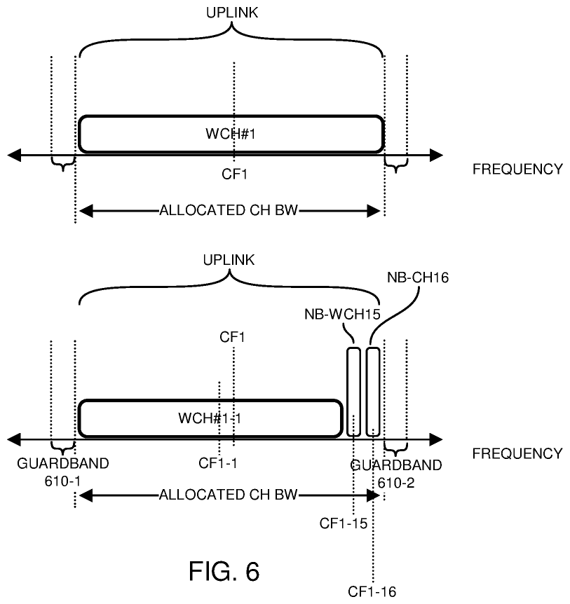

FIG. 6 is an example diagram illustrating use of a portion of an allocated channel (bandwidth) to provide narrowband wireless connectivity according to embodiments herein.

In accordance with further embodiments, the first wireless channel WCH #1 (such as CBRs channel or other suitable wireless channel) can be allocated for use as a time-division duplex wireless channel for use by the wireless base station 115 to support wireless communications.

In still further embodiments, the communication management resource 141 or other suitable entity associated with the wireless base station 115 allocates a portion of bandwidth WCH #1 associated with the allocated first wireless channel to implement one or more narrowband wireless channels to support supplemental wireless communications.

For example, assume that the bandwidth management resource 110 allocates wireless channel WCH #1 having a center carrier frequency of CF1 for use by the wireless base station 115 in a manner as previously discussed. In this example embodiment, assume further that the communication management resource 141 or other suitable entity detects the need for one or more narrow band wireless channels.

To accommodate such a need, the communication management resource 141 partitions the allocated wireless channel WCH #1 into multiple bandwidths including wireless channel WCH #1-1 (reduced portion of WCH #1 supporting wireless connectivity 126 supporting time-division duplex communications), narrow band NB-WCH15 (supporting wireless connectivity 127 and/or frequency-division duplex communications), and narrow band NB-WCH16 (supporting wireless connectivity 127 and/or frequency-division duplex communications).

Note that the narrow band wireless channels NB-WCH15 and NB-WCH16 do not reside in either guard band 610-1 or guard band 610 but instead reside within the original allocated bandwidth associated with WCH #1.

Accordingly, embodiments herein include partitioning an allocated wireless channel on an as-needed basis to support different types of connectivity.

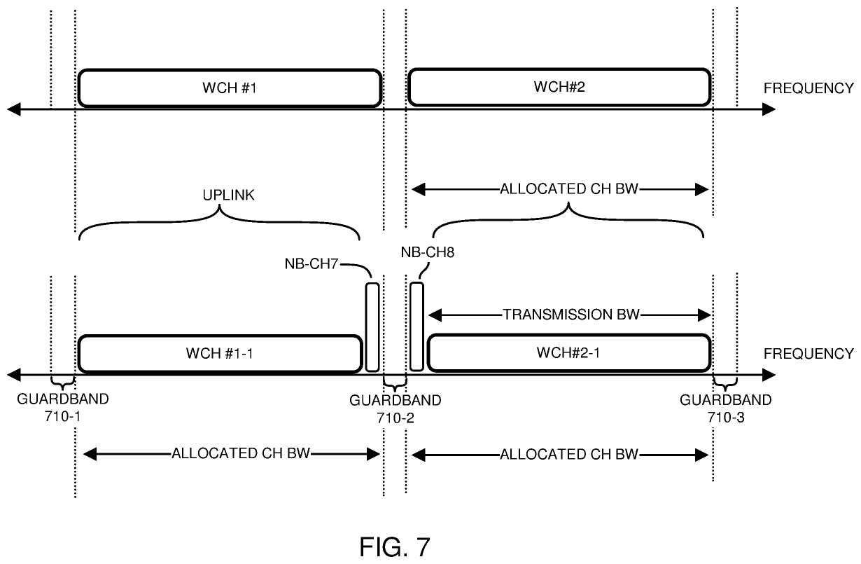

FIG. 7 is an example diagram illustrating use of a different portions of multiple allocated channels (bandwidth) to provide narrowband wireless connectivity according to embodiments herein.

In accordance with further example embodiments, the first wireless channel WCH #1 and WCH #2 (such as CBRS channels or other suitable types of wireless channels) can be allocated for use as a time-division duplex wireless channels for use by the wireless base station 115 to support wireless communications.

In accordance with further example embodiments, via subdividing the WCH #1, the communication management resource 141 or other suitable entity associated with the wireless base station 115 allocates a portion of bandwidth WCH #1 associated with the allocated first wireless channel WCH #1 to implement one or more narrowband wireless channels to support supplemental wireless communications. The communication management resource 141 or other suitable entity associated with the wireless base station 115 allocates a portion of bandwidth WCH #2 associated with the allocated second wireless channel WCH #2 to implement one or more narrowband wireless channels to support supplemental wireless communications.

For example, assume that the bandwidth management resource 110 allocates wireless channel WCH #1 having a center carrier frequency of CF1 for use by the wireless base station 115 in a manner as previously discussed. The bandwidth management resource 110 allocates wireless channel WCH #2 having a center carrier frequency of CF2 for use by the wireless base station 115.

In this example embodiment, assume further that the communication management resource 141 or other suitable entity detects the need for one or more narrow band wireless channels. To accommodate such needs, the communication management resource 141 partitions the allocated wireless channel WCH #1 into multiple bandwidths including wireless channel WCH #1-1 (supporting wireless connectivity 126) and narrow band NB-WCH7 (supporting wireless connectivity 127). The communication management resource 141 partitions the allocated wireless channel WCH #2 into multiple bandwidths including wireless channel WCH #2-1 (supporting wireless connectivity 126) and narrow band NB-WCH8 (supporting wireless connectivity 127).

Note that the narrow band wireless channels NB-WCH7 and NB-WCH8 do not reside in any of guard bands 710-1, 710-2, and guard band 710-3 but instead reside within the original allocated bandwidth associated with WCH #1 and wireless channel WCH #2 as shown in FIG. 7.

Accordingly, embodiments herein include partitioning multiple allocated wireless channels on an as-needed basis to support different types of connectivity and corresponding wireless communications.

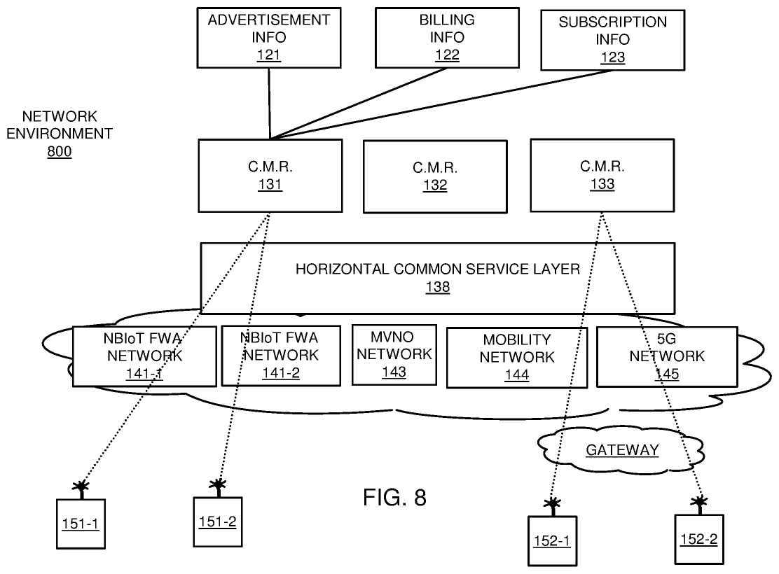

FIG. 8 is an example diagram illustrating a network environment implementing communication management and one or more wireless base stations implementing different types of wireless communication links according to embodiments herein.

In this example embodiment, network environment 800 includes network 141-1, network 141-2, MVNO network 143, Mobility network 144, 5G network 145, gateway, horizontal common service layer 138, communication management resource 131, communication management resource 132, communication management resource 133, advertisement information 121, billing information 122, and subscription information 123, and so on.

Further in this example embodiment, the network environment 800 implements an NB-IoT wireless channel implementation in a guard band of a TDD (Time Division Duplex) channel. In such an instance, via communications over the guard band (such as via network 141-1, 141-2, etc.), cellular customers (such as operators of mobile communication devices 151) may sign up for (subscribe to) NB-IoT Services such as those providing security, smart metering, pet tracking, smart metering, wearables such as smart watches, etc., to the mobile communication devices 151 via wireless communication links 127.

In accordance with yet further embodiments, the network environment 800 can be configured to provide messages to mobile communication devices 151-1, 151-2, etc., (such as smart watches, or other suitable resources) regarding an available narrowband wireless service through the fixed wireless access point (such as wireless base station 115, fixed wireless base station 116, etc.) via wireless connectivity 127 in a manner as previously discussed.

In accordance with further embodiments, a customer may have not yet signed up for a cellular service (such as use of an FWA-WCH), but may already subscribe or have access to use of a narrow band wireless channel such as NB-WCH to receive communications from one or more entities in network environment 800. In such an instance, embodiments herein include providing notification of the availability of the cellular service (or any service) via communications over the wireless channel NB-WCH. This notifies the user of availability.

In one embodiment, the narrowband FWA network (such as 141-1, 141-2, etc.) provides notification of communications derived from advertisement information 121, billing information 122, subscription information 123, etc.

In accordance with further embodiments, as previously discussed, NB-IoT or narrowband wireless technology is an FDD (Frequency Division Duplex) based technology in which separate frequency bands are used at the transmitter and receiver side to transmit and receive communications. In general, frequency-division duplex is incompatible with CBRS technology (which is a time-division duplex technology). In one nonlimiting example embodiment, as previously discussed, in order to implement a CBRS allocated wireless channel, the communication management resource can be configured to identify two frequency separated bands to support narrow band communications. In one embodiment, the isolation between two different bands (or channels) is provided by two guard bands at the opposite ends of the spectrum of the allocated wireless communication channel (such as illustrated in FIG. 3).

In accordance with still further embodiments, an HSS (Home Subscriber Server) attached component will keep tables, devices and subscriber info for IoT devices (such as mobile communication devices 151, 152, etc.). Functions running on PCRF (Policy and Charging Rules Function) and HSS will determine what messages to send to the subscriber.

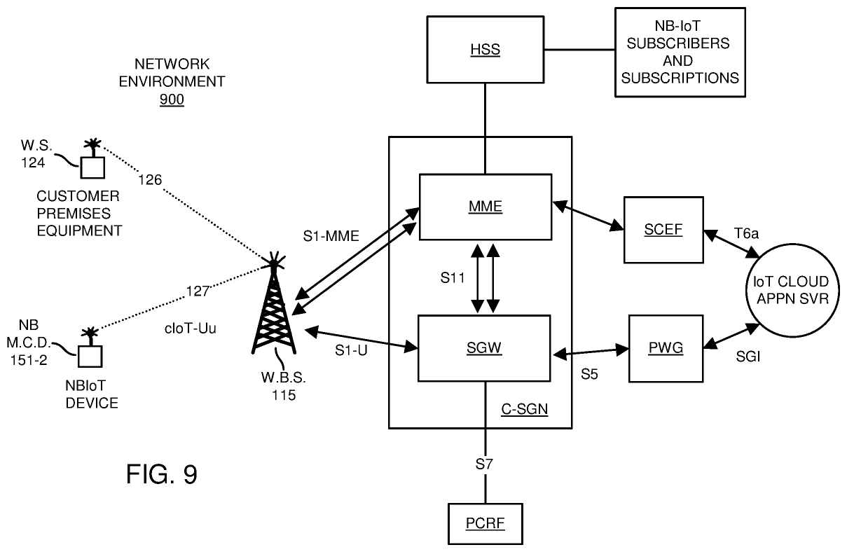

FIG. 9 is an example diagram illustrating a wireless communication system supporting multiple types of wireless connectivity according to embodiments herein.

Communication flow over a horizontal common service layer 138 is shown in network environment 900 (such as implementation of wireless network environment 800 or 900).

In one embodiment, a message created from a billing department will flow from a respective narrowband application through the horizontal IoT layer of the network 141-1 directly to the subscribers (such as mobile communication devices 151) for payment reminders and payments such as via wireless connectivity 127.

In one embodiment, a message created by the communication management resource 131 includes advertisements (from advertisement information 121) and flows directly to the subscriber operating mobile communication device 151-1. In one embodiment, a response from the subscriber would trigger necessary actions in the system.

Subscriptions to TV services for example shows and channels, and pay-per-view etc., would be communicated to the subscriber over the narrowband wireless channel via network 141-1, 141-2, etc.

As previously discussed, such a network model as described herein can be configured to distribute management information, advertisement information 121, billing information 122, subscription information 123, etc., separate from FWA channels (such as providing wireless connectivity 126) which are reserved for conveying subscriber data a video data, etc., to respective subscriber domains and subscribers.

Keeping a subscription data layer separate from the fixed wireless access layer via different types of wireless connectivity as described herein allows for better network management from one point and helps in implementing efficient use of resources. Additionally, using NB-IoT for FWA helps in relieving network traffic congestion and provides easier subscription management to the customer.

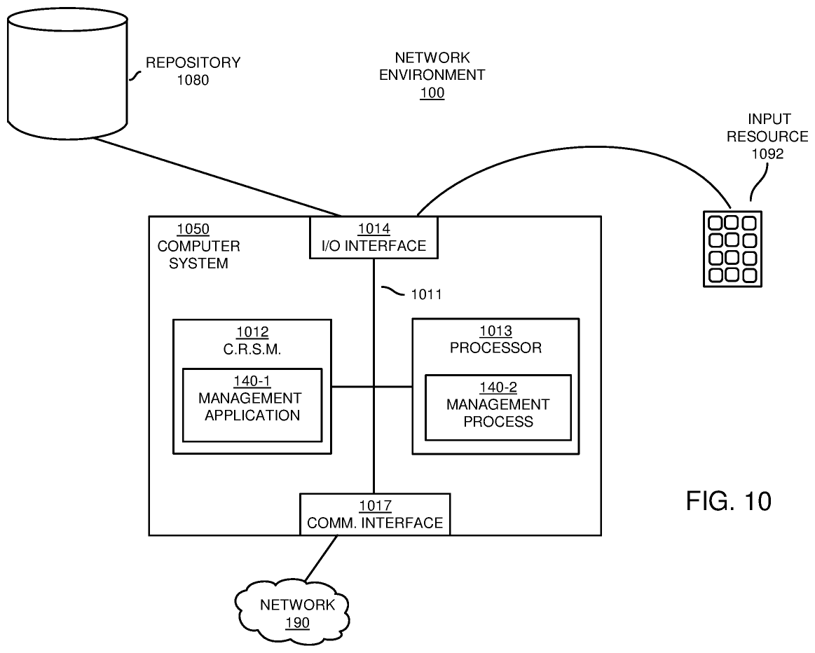

FIG. 10 is an example block diagram of a computer system for implementing any of the operations as previously discussed according to embodiments herein.

Any of the resources (such as bandwidth management resource 110, communication management resource 140, wireless base station, bandwidth management resource, mobile communication device, etc.) as discussed herein can be configured to include computer processor hardware and/or corresponding executable instructions to carry out the different operations as discussed herein.

As shown, computer system 1050 of the present example includes interconnect 1011 coupling computer readable storage media 1012 such as a non-transitory type of media (which can be any suitable type of hardware storage medium in which digital information can be stored and or retrieved), a processor 1013 (computer processor hardware), I/O interface 1014, and a communications interface 1017.

I/O interface(s) 1014 supports connectivity to repository 1080 and input resource 1092.

Computer readable storage medium 1012 can be any hardware storage device such as memory, optical storage, hard drive, floppy disk, etc. In one embodiment, the computer readable storage medium 1012 stores instructions and/or data.

As shown, computer readable storage media 1012 can be encoded with communication management application 140-1 (e.g., including instructions) in or associated with a respective wireless station to carry out any of the operations as discussed herein.

During operation of one embodiment, processor 1013 accesses computer readable storage media 1012 via the use of interconnect 1011 in order to launch, run, execute, interpret or otherwise perform the instructions in communication management application 140-1 stored on computer readable storage medium 1012. Execution of the communication management application 140-1 produces communication management process 140-2 to carry out any of the operations and/or processes as discussed herein.

Those skilled in the art will understand that the computer system 1050 can include other processes and/or software and hardware components, such as an operating system that controls allocation and use of hardware resources to execute communication management application 140-1.

In accordance with different embodiments, note that computer system may reside in any of various types of devices, including, but not limited to, a mobile computer, a personal computer system, a wireless device, a wireless access point, a base station, phone device, desktop computer, laptop, notebook, netbook computer, mainframe computer system, handheld computer, workstation, network computer, application server, storage device, a consumer electronics device such as a camera, camcorder, set top box, mobile device, video game console, handheld video game device, a peripheral device such as a switch, modem, router, set-top box, content management device, handheld remote control device, any type of computing or electronic device, etc. The computer system 1050 may reside at any location or can be included in any suitable resource in any network environment to implement functionality as discussed herein.

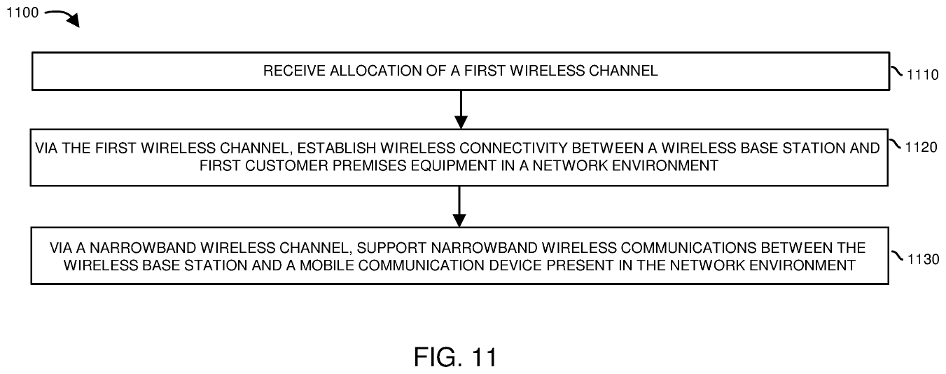

Functionality supported by the different resources will now be discussed via flowcharts in FIG. 11. Note that the steps in the flowcharts below can be executed in any suitable order.

FIG. 11 is a flowchart 1100 illustrating an example method according to embodiments herein. Note that there will be some overlap with respect to concepts as discussed above.

In processing operation 1110, the communication management resource 141 associated with wireless base station 115 initially receives allocation of a first wireless channel.

In processing operation 1120, via the first wireless channel, the communication management resource 141 establishes wireless connectivity (such as via FWA-WCH) between the wireless base station 115 and wireless station 124 such as customer premises equipment.

In processing operation 1130, via an established narrowband wireless channel (such as NB-WCH) associated with the first wireless channel (such as via FWA-WCH), the wireless base station 115 supports narrowband wireless communications between the wireless base station and one or more mobile communication devices 151-1, 151-2, etc.

Additional method operations associated with flowchart 1100 and corresponding operations have been previously discussed.

Note again that techniques herein are well suited to facilitate implementation of different types of wireless connectivity including narrow band capability in a wireless network environment. However, it should be noted that embodiments herein are not limited to use in such applications and that the techniques discussed herein are well suited for other applications as well.

Based on the description set forth herein, numerous specific details have been set forth to provide a thorough understanding of claimed subject matter. However, it will be understood by those skilled in the art that claimed subject matter may be practiced without these specific details. In other instances, methods, apparatuses, systems, etc., that would be known by one of ordinary skill have not been described in detail so as not to obscure claimed subject matter. Some portions of the detailed description have been presented in terms of algorithms or symbolic representations of operations on data bits or binary digital signals stored within a computing system memory, such as a computer memory. These algorithmic descriptions or representations are examples of techniques used by those of ordinary skill in the data processing arts to convey the substance of their work to others skilled in the art. An algorithm as described herein, and generally, is considered to be a self-consistent sequence of operations or similar processing leading to a desired result. In this context, operations or processing involve physical manipulation of physical quantities. Typically, although not necessarily, such quantities may take the form of electrical or magnetic signals capable of being stored, transferred, combined, compared or otherwise manipulated. It has been convenient at times, principally for reasons of common usage, to refer to such signals as bits, data, values, elements, symbols, characters, terms, numbers, numerals or the like. It should be understood, however, that all of these and similar terms are to be associated with appropriate physical quantities and are merely convenient labels. Unless specifically stated otherwise, as apparent from the following discussion, it is appreciated that throughout this specification discussions utilizing terms such as “processing,” “computing,” “calculating,” “determining” or the like refer to actions or processes of a computing platform, such as a computer or a similar electronic computing device, that manipulates or transforms data represented as physical electronic or magnetic quantities within memories, registers, or other information storage devices, transmission devices, or display devices of the computing platform.

While this invention has been particularly shown and described with references to preferred embodiments thereof, it will be understood by those skilled in the art that various changes in form and details may be made therein without departing from the spirit and scope of the present application as defined by the appended claims. Such variations are intended to be covered by the scope of this present application. As such, the foregoing description of embodiments of the present application is not intended to be limiting. Rather, any limitations to the invention are presented in the following claims.

1. A method comprising:
receiving allocation of a first wireless channel;
via the first wireless channel, establishing wireless connectivity between a wireless base station and first customer premises equipment in a network environment; and
via a narrowband wireless channel associated with the first wireless channel, supporting narrowband wireless communications between the wireless base station and a mobile communication device present in the network environment.

2. The method as in claim 1, wherein the first wireless channel supports time-division duplex wireless communications; and
wherein the narrowband wireless channel supports frequency-division duplex wireless communications.

3. The method as in claim 1 further comprising:
establishing the narrowband wireless channel in a guard band associated with the first wireless channel.

4. The method as in claim 1, wherein the narrowband wireless channel is a first narrowband wireless channel associated with the first wireless channel, the method further comprising:
establishing the first narrowband wireless channel in a first guard band associated with the first wireless channel; and
establishing a second narrowband wireless channel in a second guard band associated with the first wireless channel, the first narrowband wireless channel and the second narrowband wireless channel supporting full duplex communications.

5. The method as in claim 1 further comprising:
communicating a message over the narrowband wireless channel to the mobile communication device, the message indicating availability of services associated with the wireless connectivity supported by the first wireless channel.

6. The method as in claim 1 further comprising:
communicating a message over the narrowband wireless channel to the mobile communication device, the message indicating availability of content retrievable over the first wireless channel for playback by the mobile communication device.

7. The method as in claim 1 further comprising:
receiving allocation of the first wireless channel from a spectrum access system in which multiple base stations share use of a set of available wireless channels.

8. The method as in claim 1, wherein the first wireless channel is a time-division duplex wireless channel, the method further comprising:
allocating a portion of bandwidth associated with the first wireless channel to implement the narrowband wireless channel.

9. The method as in claim 1 further comprising:
adjusting a magnitude of a carrier frequency of the narrowband wireless channel, the narrowband wireless channel adjusted within a guard band associated with the first wireless channel.

10. The method as in claim 1, wherein the first wireless channel is allocated from a CBRS (Citizen Band Radio System) wireless spectrum including multiple wireless channels.

11. A method comprising:
receiving allocation of a first wireless channel;
via the first wireless channel, establishing wireless connectivity between a wireless base station and first customer premises equipment in a network environment; and
via a narrowband wireless channel associated with the first wireless channel, supporting narrowband wireless communications between the wireless base station and a mobile communication device present in the network environment, the method further comprising:
in response to receiving input indicating that the first wireless channel is no longer available for use, terminating the wireless connectivity between the wireless base station and the customer premises equipment;
in response to receiving assignment of a second wireless channel to be used in lieu of the first wireless channel, re-establishing the wireless connectivity between the wireless base station and the customer premises equipment; and
re-establishing the narrowband wireless channel between the wireless base station and the mobile communication device via bandwidth associated with the second wireless channel, the re-established narrowband wireless channel supporting the narrowband wireless communications between the wireless base station and the mobile communication device.

12. The method as in claim 11, wherein the narrowband wireless channel is established in a guard band associated with the first wireless channel prior to assignment of the second wireless channel to the wireless base station; and
wherein the narrowband wireless channel is re-established in a guard band associated with the second wireless channel subsequent to assignment of the second wireless channel to the wireless base station.

13. A system comprising:
communication management hardware associated with a wireless base station, the communication management hardware operative to:
receive allocation of a first wireless channel;
via the first wireless channel, establish wireless connectivity between a wireless base station and first customer premises equipment in a network environment; and
via a narrowband wireless channel, support narrowband wireless communications between the wireless base station and a mobile communication device present in the network environment.

14. The system as in claim 13, wherein the first wireless channel supports time-division duplex wireless communications; and
wherein the narrowband wireless channel supports frequency-division duplex wireless communications.

15. The system as in claim 13, wherein the communication management hardware is further operative to:
establish the narrowband wireless channel in a guard band associated with the first wireless channel.

16. The system as in claim 13, wherein the narrowband wireless channel is a first narrowband wireless channel associated with the first wireless channel, the communication management hardware further operative to:
establish the first narrowband wireless channel in a first guard band associated with the first wireless channel; and
establish a second narrowband wireless channel in a second guard band associated with the first wireless channel, the first narrowband wireless channel and the second narrowband wireless channel supporting full duplex communications.

17. The system as in claim 13, wherein the communication management hardware is further operative to:
communicate a message over the narrowband wireless channel from the wireless base station to the mobile communication device, the narrowband message indicating availability of services associated with the wireless connectivity supported by the first wireless channel.

18. The system as in claim 13, wherein the communication management hardware is further operative to:
communicate a message over the narrowband wireless channel to the mobile communication device, the narrowband message indicating availability of content retrievable over the first wireless channel for playback by the mobile communication device.

19. The system as in claim 13, wherein the communication management hardware is further operative to:
receive allocation of the first wireless channel from a spectrum access system in which multiple base stations share use of a set of available wireless channels.

20. The system as in claim 13, wherein the first wireless channel is a time-division duplex wireless channel, the communication management hardware further operative to:
allocate a portion of bandwidth associated with the first wireless channel to implement the narrowband wireless channel.

21. The system as in claim 13, wherein the communication management hardware is further operative to:
adjust a magnitude of a carrier frequency of the narrowband wireless channel, the narrowband wireless channel adjusted within a guard band associated with the first wireless channel.

22. The system as in claim 13, wherein the first wireless channel is allocated from a CBRS (Citizen Band Radio System) wireless spectrum including multiple wireless channels.

23. The system as in claim 13, wherein the communication management hardware is further operative to:
in response to receiving input indicating that the first wireless channel is no longer available for use, terminate the wireless connectivity between the wireless base station and the first customer premises equipment;
in response to receiving assignment of a second wireless channel to be used in lieu of the first wireless channel, re-establish the wireless connectivity between the wireless base station and the first customer premises equipment; and
re-establish the narrowband wireless channel between the wireless base station and the mobile communication device via bandwidth associated with the second wireless channel, the re-established narrowband wireless channel supporting the narrowband wireless communications between the wireless base station and the mobile communication device.

24. The system as in claim 23, wherein the narrowband wireless channel is established in a guard band associated with the first wireless channel prior to assignment of the second wireless channel to the wireless base station; and
wherein the narrowband wireless channel is re-established in a guard band associated with the second wireless channel subsequent to assignment of the second wireless channel to the wireless base station.

25. Computer-readable storage hardware having instructions stored thereon, the instructions, when carried out by computer processor hardware, cause the computer processor hardware to:
receive allocation of a first wireless channel;
via the first wireless channel, establish wireless connectivity between a wireless base station and first customer premises equipment in a network environment; and
via a narrowband wireless channel, support narrowband wireless communications between the wireless base station and a mobile communication device present in the network environment.

26. The method as in claim 4, wherein the full duplex communications include uplink communications over the first narrowband wireless channel from the mobile communication device and the wireless base station; and
wherein the full duplex communications include downlink communications over the second narrowband wireless channel from the wireless base station to the mobile communication device.

27. The method as in claim 1 further comprising:
receiving allocation of a second wireless channel in addition to allocation of the first wireless channel, the second wireless channel adjacent to the first wireless channel in a wireless spectrum; and
wherein the narrowband wireless channel resides between the first wireless channel and the second wireless channel.

28. The method as in claim 27 further comprising:
selecting the narrowband wireless channel to reside in a guard band between the first wireless channel and the second wireless channel.

29. The method as in claim 1, wherein the first wireless channel supports broadband communications with respect to the narrowband wireless communications transmitted over the narrowband wireless channel.

30. The method as in claim 1, wherein the narrowband wireless channel is a portion of the first wireless channel, which is allocated to the wireless base station.

31. The method as in claim 1, wherein the narrowband wireless channel is a portion of unallocated bandwidth adjacent to the first wireless channel.

32. The method as in claim 1, wherein the wireless connectivity includes a first less-than-all bandwidth portion of the first wireless channel.

33. The method as in claim 32, wherein the narrowband wireless channel is a second less-than-all bandwidth portion of the first wireless channel.

34. The method as in claim 1, wherein the narrowband wireless channel is a first narrowband wireless channel; and
wherein the first wireless channel is partitioned to include the first narrowband wireless channel and a second narrowband wireless channel.

35. The method as in claim 1 further comprising:
in response to receiving assignment of a second wireless channel to be used in lieu of the first wireless channel, re-establishing the wireless connectivity between the wireless base station and the customer premises equipment via the second wireless channel; and
re-establishing the narrowband wireless channel between the wireless base station and the mobile communication device via bandwidth associated with the second wireless channel, the re-established narrowband wireless channel supporting the narrowband wireless communications between the wireless base station and the mobile communication device.

36. The method as in claim 1, wherein the narrowband wireless channel is a first narrowband wireless channel, the first narrowband wireless channel being a first less-than-all portion of the first wireless channel, the method further comprising:
receiving allocation of a second wireless channel;
partitioning the second wireless channel to include a second narrowband wireless channel, the second narrowband wireless channel being a first less-than-all portion of the second wireless channel.

37. The method as in claim 36, wherein a guard band resides between the first narrowband wireless channel and the second narrowband wireless channel.

38. The method as in claim 36, wherein a combination of the first narrowband wireless channel and the second narrowband wireless channel reside between a second less-than-all portion of the first wireless channel and a second less-than-all portion of the second wireless channel.
